(19) United States
(12) Patent Application Publication
(10) Pub. No.: US 2007/0104355 A1
(43) Pub. Date: May 10, 2007

(54) Test tool used by a skin pattern reader

(75) Inventors: Chia-Chu Cheng, Hsin-Tien City (TW); Shih-Pin Wu, Hsin-Tien City (TW); Tzu-Heng Liu, Hsin-Tien City (TW); Yu-Wei Lu, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/594,133

(22) Filed: Nov. 8, 2006

(30) Foreign Application Priority Data
Nov. 8, 2005 (TW) 94139194

(51) Int. Cl. G06K 9/00

(52) U.S. Cl. 382/115

(57) ABSTRACT

A test tool used by a skin pattern reader includes a flexible body and a fixing clamp. The flexible body has a lumpy surface or a flat surface. The flexible body is made of material having a refractive index the same as human skin. The fixing clamp is used to fix the flexible body. The fixing clamp also drives the flexible body to let its lumpy surface press close to the skin pattern reader, so as to perform related function testing of the skin pattern reader. Through a flexible body having a refractive index similar to human skin, a standardized golden sample can be established, and drawbacks in the prior art caused by a flat sheet of paper having alternately-arranged stripes or by the skin pattern of the testee can also be solved.

### BACKGROUND OF THE INVENTION

1. Field of the invention

The present invention relates to a test tool used by a skin pattern reader and, more particularly, to a test tool for performing related function testing of a skin pattern reader by using a flexible body having a refractive index similar to human skin.

2. Description of Related Art

The skin pattern is the best certificate of a person's identity. The skin pattern of every person is not exactly the same, and is hard to alter. The identity of a user can be confirmed through the discrimination of the skin pattern. Therefore, this identity recognition tool of high safety has become an essential equipment for the protection and manifestation of the identity. In the future, because people will pursue higher convenience and comfort, the skin pattern recognition will inevitably be used to replace or assist general common identity recognition means.

An optical skin pattern recognition device converts the unevenness to the variation of light magnitude, and then converts the variation of light magnitude to a corresponding electric signal by means of photography. The obtained electric signal is compared with the electric signal of the user himself that is stored in advance to make sure whether the testee is the user himself.

In the above skin pattern recognition device, the quality testing of its skin pattern reader at production time is very important, and affects the rights and interests of the user much. Generally speaking, there are three test methods of the skin pattern reader in the prior art:

1. Scattering type:
Image contrast signals of the ridges and valleys of the skin pattern are directly read in a manner similar to the copier. Usually, a stronger stripe signal represents the ridge of the skin pattern, and a weaker stripe signal represents the valley of the skin pattern.

2. Total internal reflection type:
The refractive index of the air at the valleys of the skin pattern is 1, the refractive index of the epidermis of the skin is 1.4˜1.55, and the refractive index of the prism is 1.5. The skin pattern press close to the inclined plane of the prism of the skin pattern reader to let the light beam of the light source be incident to the skin pattern with an incident angle larger than the critical angle. Because there is a large difference of refractive index between the air and the prism, total internal reflection will occur at the valleys of the skin pattern, and the light beam will reach the light sensor. Therefore, the sensor of the skin pattern reader reads a brighter value. Under the condition of the same incident angle, because the skin and the prism have close refractive indices, no total internal reflection occurs at the ridges of the skin pattern, and the light beam penetrates the skin, meaning a loss to the light sensor. Therefore, the sensor of the skin pattern reader reads a dimmer value. Through the determination of whether total internal reflection occurs, the sensor of the skin pattern reader can obtain bright and dark stripes to get the ridge and valley information of the skin pattern.

3. Proximity type:
The refractive index of the air at the valleys of the skin pattern is 1, the refractive index of the epidermis of the skin is 1.4˜1.55, and the refractive index of a transparent cover is 1.5. When a light beam passes through the ridges of the skin pattern and then the transparent cover, because the refractive indices of the skin at the ridges of the skin pattern and the transparent cover are closer, a higher transmittance is obtained at the skin/cover interface. Therefore, the sensor of the skin pattern reader reads a brighter value. When the light beam passes through the valleys of the skin pattern and the air, because there is a large difference of refractive index between the air and the skin at the valleys of the skin pattern, a lower transmittance is obtained. Similarly, when the light beam further passes through the air and then the transparent cover, the transmittance will decrease once more because of a larger difference of refractive index across the interface. Therefore, the sensor of the skin pattern reader reads a dimmer value. In this way, the sensor of the skin pattern reader can obtain bright and dark stripes to get the ridge and valley information of the skin pattern.

Moreover, in order to let the skin pattern reader have a test standard of skin pattern, a plain sheet of paper having alternately-arranged stripes is conventionally used to emulate the ridges and valleys of the skin pattern so as to perform related function testing of the skin pattern reader. The above method, however, cannot emulate the refractive index of the air part, and is therefore only suitable to the scattering type, but is unsuitable to the total internal reflection type or the proximity type.

For the testing of the total internal reflection type or the proximity type, a manual test is usually adopted, in which the skin pattern of a testee is directly used to perform related function testing. Although testing carried out in this manner are the closest to the actual use state, much manpower is consumed and the efficiency of testing is low. Besides, because the skin pattern of every testee is not exactly the same, a standardized golden sample cannot be obtained.

Accordingly, the test tool (including a plain sheet of paper having alternately-arranged stripes or the skin pattern of the testee) of the conventional skin pattern reader has inconvenience and drawbacks in practical use. The present invention aims to propose a test tool used by a skin pattern reader to effectively improve the above problems in the prior art.

### SUMMARY OF THE INVENTION

The primary object of the present invention is to provide a test tool used by a skin pattern reader, in which a flexible body having a refractive index similar to human skin is used to establish a standardized golden sample and solve the drawbacks caused by a plain sheet of paper having alternately-arranged stripes or the skin pattern of the testee in the prior art. Moreover, the present invention can emulate the refractive index of the air part. Therefore, the present invention can apply to any test method of the skin pattern reader in the prior art (e.g., the scattering type, the total internal reflection type or the proximity type) to perform related function testing of the skin pattern reader.

To achieve the above object, the present invention provides a test tool used by a skin pattern reader, which tool comprises a flexible body and a fixing clamp. The flexible body has a lumpy surface, and is made of material having the same refractive index as human skin. The fixing clamp is used to fix the flexible body and drive the flexible body to let its lumpy surface press close to the skin pattern reader so as to perform related function testing of the skin pattern reader.

To achieve the above object, the present invention also provides a test tool used by a skin pattern reader, which tool comprises a flexible body and a fixing clamp. The flexible body has a flat surface, and is made of material having the same refractive index as human skin. The fixing clamp is used to fix the flexible body and drive the flexible body to let its flat surface press close to the skin pattern reader so as to perform quality control testing of the skin pattern reader.

### BRIEF DESCRIPTION OF THE DRAWINGS

The various objects and advantages of the present invention will be more readily understood from the following detailed description when read in conjunction with the appended drawing, in which:

FIG. 1 is a side view of a test tool used by a skin pattern reader according to a first embodiment of the present invention;

FIG. 2 is a top view of a test tool used by a skin pattern reader according to the first embodiment of the present invention;

FIG. 3 is a top view of a test tool used by a skin pattern reader according to a second embodiment of the present invention;

FIG. 4 is a top view of a test tool used by a skin pattern reader according to a third embodiment of the present invention; and

FIG. 5 is a side view of a test tool used by a skin pattern reader according to a fourth embodiment of the present invention.

### DETAILED DESCRIPTION OF THE PREFERRED EMBODIMENTS

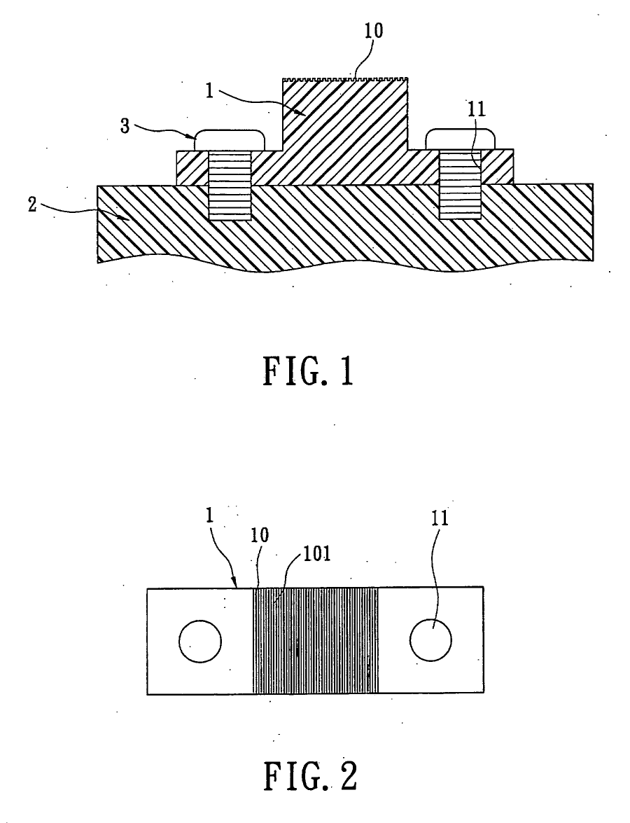

FIGS. 1 and 2 are a side view and a top view of a test tool used by a skin pattern reader according to a first embodiment of the present invention, respectively. As shown in FIGS. 1 and 2, the present invention provides a test tool used by a skin pattern reader, which tool comprises a flexible body 1 and a fixing clamp 2.

The flexible body 1 can be made of other materials, such as rubber, silicone, polymer, gel, or etc . . . The flexible body 1 has a lumpy surface 10, and is made of material having the same refractive index as human skin. The refractive index of human skin is between 1.4 and 1.6 (preferred to be 1.5). The lumpy surface 10 can have periodic or aperiodic stripes. In the first embodiment, the stripes are straight-line stripes 101.

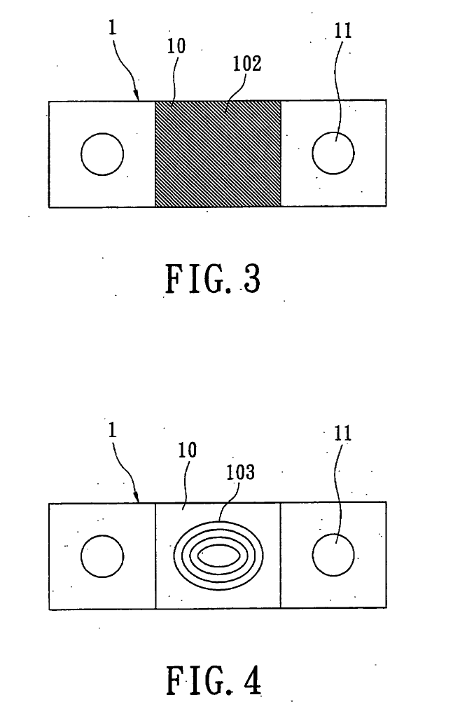

FIGS. 3 and 4 are top views of a test tool used by a skin pattern reader according to a second embodiment and a third embodiment of the present invention, respectively. As shown in FIGS. 3 and 4, the stripes can be oblique-line stripes 102 (FIG. 3), concentric stripes, spiral stripes 103 (FIG. 4), or stripes of an arbitrary shape to meet the user's requirements.

Moreover, for the structure of the lumpy surface 10 of the flexible body 1, the width w between ridges or valleys of the lumpy surface 10 is between 0.01 mm and 1 mm, and the depth d between the ridge and valley of the lumpy surface 10 is between 0.01 mm and 1 mm. In the present invention, however, the width w and the depth d are not limited to this range. Besides, the flexible body 1 can also be made of translucent material having the same refractive index, scattering, and optical attenuation properties as human skin.

Two fixing members 3 can be used to pass two through holes 11 of the flexible body 1 so as to fix the flexible body 2 onto the fixing clamp 2. The present invention is not limited to the above manner of fixing the flexible body 1 onto the fixing clamp 2. Any manner of fixing or positioning the flexible body 1 onto the fixing clamp 2 is embraced within the scope of the present invention. Furthermore, the fixing clamp 2 can drive the flexible body 1 to let the lumpy surface 10 of the flexible body 1 press close to the skin pattern reader (not shown) so as to perform related function testing of the skin pattern reader.

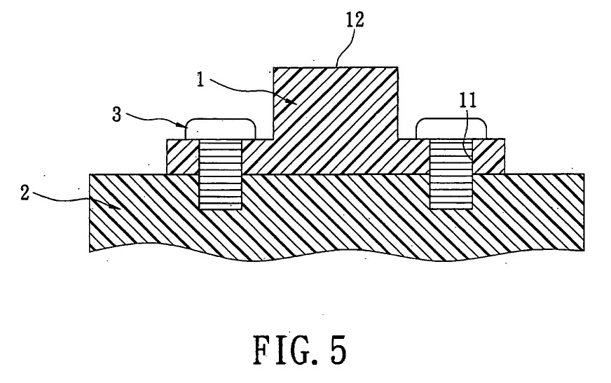

FIG. 5 is a side view of a test tool used by a skin pattern reader according to a fourth embodiment of the present invention. The fourth embodiment differs from other embodiments in that the flexible body 1 has a flat surface 12. The fixing clamp 2 can drive the flat surface 12 of the flexible body 1 to press close to the skin pattern reader so as to perform quality control testing of the skin pattern reader. That is, the skin pattern reader can first used a sensor to sense the flat surface 12 of the flexible body 1 to get totally dark or total bright skin pattern information. Next, whether the illumination is uniform and whether there are white points (defects) in the totally dark skin pattern information or whether there are black points (defects) in the totally bright skin pattern information are determined. Through the above testing, whether the quality of the skin pattern reader conforms to the standard can be determined.

To sum up, the present invention makes use of a flexible body 1 having a refractive index similar to human skin to establish a standardized golden sample and solve the drawbacks caused by a plain sheet of paper having alternately-arranged stripes or the skin pattern of the testee in the prior art. Moreover, because the present invention can emulate the refractive index of the air part, the present invention can apply to any test method of the skin pattern reader in the prior art (e.g., the scattering type, the total internal reflection type or the proximity type) so as to perform related function testing of the skin pattern reader.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A test tool used by a skin pattern reader, comprising:
a flexible body having a lumpy surface and made of material having a refractive index the same as human skin; and
a fixing clamp used to fix said flexible body and drive said flexible body to let said lumpy surface of said flexible body press close to said skin pattern reader so as to perform related function testing of said skin pattern reader.

2. The test tool used by a skin pattern reader as claimed in claim 1, wherein the refractive index of the human skin is between 1.4 and 1.6.

3. The test tool used by a skin pattern reader as claimed in claim 1, wherein said flexible body is made of material having the same light scattering characteristic as human skin.

4. The test tool used by a skin pattern reader as claimed in claim 1, wherein said flexible body is made of material having the same light attenuation characteristic as human skin.

5. The test tool used by a skin pattern reader as claimed in claim 1, wherein said flexible body is made of material selected from the group consisting of rubber, silicone, polymer, and gel.

6. The test tool used by a skin pattern reader as claimed in claim 1, wherein said lumpy surface has periodic or aperiodic stripes.

7. The test tool used by a skin pattern reader as claimed in claim 6, wherein said stripes are straight-line stripes, oblique-line stripes, concentric stripes, or spiral stripes.

8. The test tool used by a skin pattern reader as claimed in claim 1, wherein the width between ridges or valleys of said lumpy surface is between 0.01 mm and 1 mm, and the depth between ridge and valley of said lumpy surface is between 0.01 mm and 1 mm.

9. A test tool used by a skin pattern reader comprising:
a flexible body having a flat surface and made of material having a refractive index the same as human skin; and
a fixing clamp used to fix said flexible body and drive said flexible body to let said flat surface of said flexible body press close to said skin pattern reader so as to quality control testing of said skin pattern reader.

10. The test tool used by a skin pattern reader as claimed in claim 9, wherein the refractive index of the human skin is between 1.4 and 1.6.

11. The test tool used by a skin pattern reader as claimed in claim 9, wherein said flexible body is made of material having the same light scattering characteristic as human skin.

12. The test tool used by a skin pattern reader as claimed in claim 9, wherein said flexible body is made of material having the same light attenuation characteristic as human skin.

13. The test tool used by a skin pattern reader as claimed in claim 9, wherein said flexible body is made of material selected from the group consisting of rubber, plastic, silicone, polymer, and gel.
